(19) United States
(12) Patent Application Publication
(10) Pub. No.: US 2010/0306023 A1
(43) Pub. Date: Dec. 2, 2010

(54) Systems and Methods of Selecting Advertisements Using a Local User Profile

(75) Inventors: Catalin Grigoroscuta, Bucharest (RO); Alexandru Costin, Bucharest (RO); Phillip Ydens, Campbell, CA (US); Mitch Green, Boulder, CO (US); David Burkett, Los Gatos, CA (US); Murugappan Palaniappan, Issaquah, WA (US)

Correspondence Address: Kilpatrick Stockton LLP- Adobe Systems, Inc. 58083, Kilpatrick Stockton LLP, 1100 Peachtree Street, Atlanta, GA, 30309-4530, US

(73) Assignee: Adobe Systems Incorporated, San Jose, CA (US)

(21) Appl. No.: 12/474,341

(22) Filed: May 29, 2009

(51) Int. Cl. G06Q 30/00; G06Q 99/00

(52) U.S. Cl. 705/10; 705/26; 705/14.53; 705/14.66

(57) ABSTRACT

Systems and methods are disclosed for providing user-targeted advertisements to content recipients. Such advertisements may, for example, be selected using a user profile that is maintained locally at the recipient's computing or other content consuming device. A user profile can include information about the user's past viewing behavior. One exemplary embodiment uses a local content player software application to maintain a user profile based on contextual, behavioral, demographic, and other data linked to the content, the user's viewing habits, and/or location, among other things. Such a content player can select advertisements by matching user content information with user profile information. User profile information can be limited to local use to protect user privacy concerns.

### FIELD

This disclosure generally relates to computer software that runs, displays, provides, or otherwise uses electronic content.

### BACKGROUND

Various types of software are used to run, display, provide, and otherwise use electronic content. Various players and readers include, as examples, Adobe® Reader®, Adobe® Flash Player®, Adobe Flash Lite™, Microsoft® Internet Explorer®, Microsoft® Windows Media® Player, Microsoft® Silverlight™, iTunes®, iMovie®, and RealPlayer®. For simplicity, both “players” and “readers” are referred to herein simply as “players” and both “content” and “applications” are referred to simply as “content.” Content is also provided by a variety of Internet server devices and applications.

Advertisements are frequently appended to or otherwise included in content. Advertisers and content providers have used many techniques to provide advertisements that are the most enticing for the viewers of the associated content. For example, the subject matter of the content is often used to identify advertisements that will better target the likely general audience of the piece of content. While such content matching techniques can generally identify possible subject matter for matching relevant advertising, they fail to account for the individual user's particular interests. Other techniques that do take into account a user's interests and past behavior in contrast do so at the expense of the user's privacy. For example, user interaction on the Internet with various websites, movies, and other consumed content can be tracked to identify user likes and dislikes. This information can then be used to create a user profile on a server, that is then used to select advertisements to provide to that user. Generally, current techniques fail to sufficiently facilitate advertisement targeting, user privacy protection, and/or account for transmission and bandwidth considerations.

### SUMMARY

Systems and methods are disclosed for selecting and providing advertisements based on a locally constructed user profile while reducing or eliminating any sending of user information outside the user's local machine. One exemplary workflow can use a local content player software application on a user's own computing device to construct and maintain a user profile based on contextual, behavioral, demographic, and other data linked to the content, the user's viewing habits, and/or location, among other things. When a user views a video, for example, with advertising in it, an advertisement server can identify possible advertisements that match the video content along with information about each possible advertisement. The content player can then select, retrieve, and display the advertisement(s) that best match the local user profile using the information. In this example, the user's privacy is protected since the user's past actions and behaviors are used to select an appropriate advertisement without sending information about those past behaviors outside of the user's local device.

One exemplary method of selecting an advertisement using a local user profile involves sending a request for content to play, receiving the requested content and information about possible advertisements, selecting an advertisement from the possible advertisements using a local user profile, requesting the selected advertisement from a remote source, and playing the requested content and the selected advertisement together. A content player on a computer apparatus, in certain embodiments, may maintain the user profile based at least in part on information about content that was previously requested for playing on the computer apparatus.

Another exemplary method of maintaining a local user profile involves sending a request for content to play, receiving the requested content, identifying information about the requested content, and updating a user profile using that information about the requested content. The user profile, in certain embodiments, is maintained locally on the computer apparatus and is not provided to remote computer devices, such as remote content providers or remote advertisement providers.

These exemplary embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1a-b are system diagrams illustrating illustrative network environments, according to certain embodiments;

FIG. 2 is a flow chart illustrating an exemplary method of maintaining a local user profile according to certain embodiments;

FIG. 3 is a flow chart illustrating an exemplary method of selecting advertisements using a local user profile, according to certain embodiments;

FIG. 4 illustrates an exemplary method of providing content with information about possible advertisements to facilitate selection of an advertisement on a user device, according to certain embodiments;

FIG. 5 illustrates an exemplary response to such a request performed by a remote content or advertisement provider, according to certain embodiments;

FIG. 6 is a flow chart illustrating another exemplary method of selecting advertisements using a local user profile, according to certain embodiments; and

FIG. 7 illustrates an exemplary method of providing content and possible advertisements to facilitate selection of an advertisement on a user device, according to certain embodiments.

### DETAILED DESCRIPTION

Systems and methods are disclosed for providing user-targeted advertisements to content recipients. Such advertisements may, for example, be selected using a user profile that is maintained locally at the recipient's computing or other content consuming device. A user profile can include information about the user's past viewing behavior. For example, a profile may include subject matter interests and other information about a user identified by tracking that the user watched certain movies or accesses certain websites. One exemplary embodiment uses a local content player software application to maintain a user profile based on contextual, behavioral, demographic, and other data linked to the content, the user's viewing habits, and/or location, among other things. Certain embodiments protect user privacy by limiting the information that is sent from the user's computer. User profile information can, for example, be limited to local use to protect user privacy concerns.

A content providing server or another server or device can identify several possible advertisements that are appropriate for content being provided to a recipient user. Possible or potential advertisements refer to a set of one or more advertisements, at least one of which may be presented by a content player in conjunction with playing requested content. Possible advertisements may be identified or otherwise selected for use based on the respective advertisement's degree of fitness/appropriateness/relevance in view of the given local user profile. A recipient's content player can select advertisements by identifying which of the possible advertisements best match locally-stored user profile information. The content player can then request the selected advertisements without sending any user profile information. In certain embodiments, a server sends URL or other advertisement identifiers for each of several possible advertisements and/or some metadata about each advertisement. This information allows the content player to select and request appropriate advertisements. The server receives the request for that particular advertisement and provides for use with the content.

Information about advertisements that is provided to a user can be maintained by the provider of the content or by a separate entity or server. A content may completely externalize the advertisement process. For example, a user requesting to play a video content can cause a content provider to contact another party or server to request a playlist that will include the content and one or more advertisements. The other party or server can provide information about possible information to the content provider who can then pass the playlist, the requested content, and the information about possible advertisements on to the requesting recipient user.

Certain embodiments allow user-targeted advertising to be provided with content while preserving user privacy while reducing the amount of extraneous material provided to the user. For example, information about possible advertisements can be provided to allow the client device to select amongst possible advertisements without requiring that the user device actually receive all of the possible advertisements.

In other embodiments, the possible advertisements are actually sent or delivered to the user device with or without separate or meta information and the content player can simply select amongst them using the information and/or by interpreting the advertisements. In these exemplary embodiments, a content player does not need to separately request one or more selected advertisements, further protecting the user's privacy by eliminating the possibility that the content server could infer information about a user based on the fact that a particular advertisement was requested.

These illustrative examples are given to introduce the reader to the general subject matter discussed herein and are not intended to limit the scope of the disclosed concepts. The following sections describe various additional embodiments and examples of methods and systems of selecting advertisements using a local user profile.

### Illustrative Networks and Content Consumption Devices

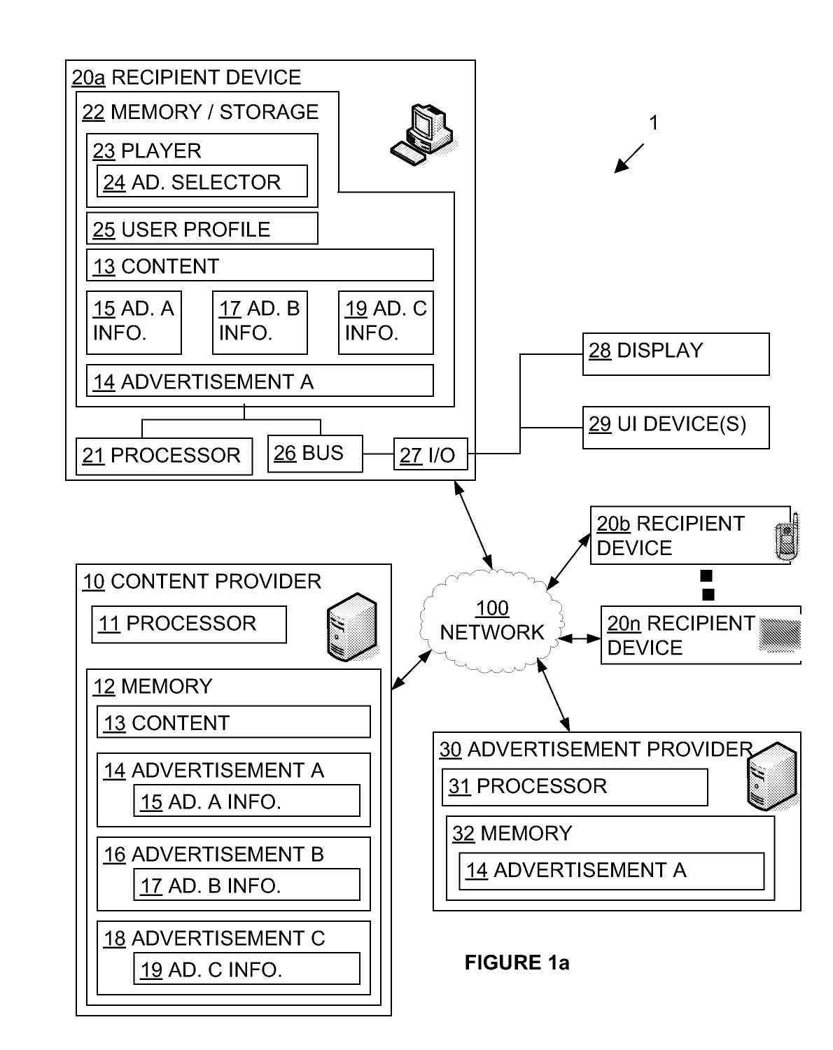

Referring now to the drawings in which like numerals indicate like elements throughout the several Figures, FIG. 1a is a system diagram illustrating an illustrative network environment according to certain embodiments. Other embodiments may be utilized. The environment 1 shown in FIG. 1a comprises a wired or wireless network 100 connecting various network devices 10, 20a-n, 30. Exemplary applications that execute on each of the devices 10, 20a-n, 30 are shown as functional or storage components residing in memory 12, 22, 32 on the respective devices. The memory 12, 22, 32 may be transient or persistent. As is known to one of skill in the art, such applications may be resident in any suitable computer-readable medium and execute on any suitable processor. For example, the network devices 10, 20, 30 shown each may comprise a computer-readable medium such as a random access memory (RAM) 12, 22, 32 coupled to a processor 11, 21, 31 that executes computer-executable program instructions and/or accesses information stored in memory 12, 22, 32. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

The network 100 shown comprises the Internet. In other embodiments, other networks, intranets, combinations of networks, or no network may be used. The devices 10, 20a-n, 30 can be connected to a network 100 as shown. Alternative configurations are of course possible. The devices 10, 20, 30 may also comprise a number of external or internal devices such as a mouse, a CD-ROM, DVD, a keyboard, a display, audio speakers, or other input or output devices. For example, recipient device 20 includes a display 28 and various user interface devices 29. The provider devices 10, 30 depicted as single computer systems, may be implemented as a network of computers, servers, or processors. Examples of a server device are servers, mainframe computers, networked computers, a processor-based device, and similar types of systems and devices.

An exemplary content provider device 10 may be configured to provide a piece of content 13 for distribution to one or more computing apparatuses, for example, by distributing the piece of content through a network 100 or making the content available for download through a network 100. The content provider may provide advertisement info 15, 17, 19 for possible advertisements 14, 16, 18 that can be displayed or otherwise provided to the user with the content 13. For example, if content 13 is video content, the possible advertisements 14, 16, 18 may be video advertisements that will be played to users prior to, during, or after the video content plays, or in other forms.

Recipients 20a-n are computing devices that can be specifically configured to receive and/or play pieces of electronically stored and/or electronically distributed content. For example, an exemplary computer apparatus may comprise content playing software that provides instructions embodied in a computer-readable medium. When configured according to the instructions of the content playing software, the computer apparatus is able to function as a content player 23 to play electronically-stored or electronically-distributed content. For example, a device may display graphics or video content that is stored as an electronic file. As another example, a device may play a piece of audio content. Examples of devices include, but are not limited to, personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media consuming programs.

An exemplary recipient 20a comprises an exemplary player 23. This content player 23 includes an advertisement selector 24 that can select advertisements to be played with various pieces of content played by the player 23. In this example, the player 23 receives content 13 from content provider 10. The player 23 also receives advertisement information 15, 17, 19 for three possible advertisements 14, 16, 18, one or more of which will be selected to be played with the content 13. The advertisement selector 24 uses this advertisement information 15, 17, 19 and a locally-stored user profile 25 to select an appropriate advertisement. In this example, advertisement A 14 is selected and downloaded to the recipient device 20a. As illustrated, the content provider 10 can provide the advertisement A 14 or a separate advertisement provider 30 can provide the advertisement A 14 to the recipient device 20a. For example, the advertisement A information 15 can include a uniform resource locator address that allows the player 23 to directly contact the separate advertisement provider 30.

FIG. 1b is another system diagram illustrating a different illustrative network environment 50, which comprises a network 100 connecting various devices 60, 70a-n. The devices 60, 70a-n each may comprise a computer-readable medium such as a random access memory (RAM) 62, 72 coupled to a processor 61, 71 that executes computer-executable program instructions and/or accesses information stored in memory 62, 72. The devices 60, 70 may also comprise a number of external or internal devices such as a mouse, a CD-ROM, DVD, a keyboard, a display, audio speakers, or other input or output devices. For example, recipient device 70a includes a display 78 and various user interface devices 79. The content provider device 60 depicted as a single computer system, may be implemented as a network of computers, servers, or processors.

An exemplary content provider device 60 may be configured to provide a piece of content 63 for distribution to one or more computing apparatuses, for example, by distributing the piece of content 63 through the network 100 or making the content 63 available for download through the network 100. The content provider device 60 may also store a plurality of possible advertisements 64, 66, 68 that can be displayed or otherwise provided to the user with the content 13. A recipient device, such as recipient device 70a, is configured to receive and/or play pieces of electronically stored and/or electronically distributed content. An exemplary recipient 70a comprises an exemplary player 73. This content player 73 includes an advertisement selector 74 that can select advertisements to be played with various pieces of content played by the player 73. In this example, the player 73 receives content 63 and possible advertisements 64, 66, 68 from content provider 60. The advertisement selector 74 uses a locally-stored user profile 75 to select an appropriate advertisement from the possible advertisements 64, 66, 68. For example, the advertisement selector 74 may identify information about the possible advertisements 64, 66, 68 from the advertisements themselves and/or from another source and compare that information with the user profile 75 information. The player 73 plays the content 63 with a selected advertisement. Advertisements that are not selected for playing with the content can be discarded or saved for later use on the recipient device 70a.

These exemplary network and device configurations 1, 50 are provided merely to illustrate various potential configurations that can be used to implement certain embodiments. Other configurations may of course be utilized.

### Exemplary Methods of Maintaining a Local User Profile

A content player or other user profile maintaining application may actively construct and maintain a user profile based on contextual, behavioral, demographical and other data linked to a user's content viewing habits, timing and/or location. Over time as more content is viewed, embodiments can keep track of a potentially vast volume of information in a variety of ways. For example, content may be categorized such that the a user's subject matter interests can be assumed using the content categories for which the user has viewed the most content. Other techniques, including the other exemplary techniques described herein, can also be used.

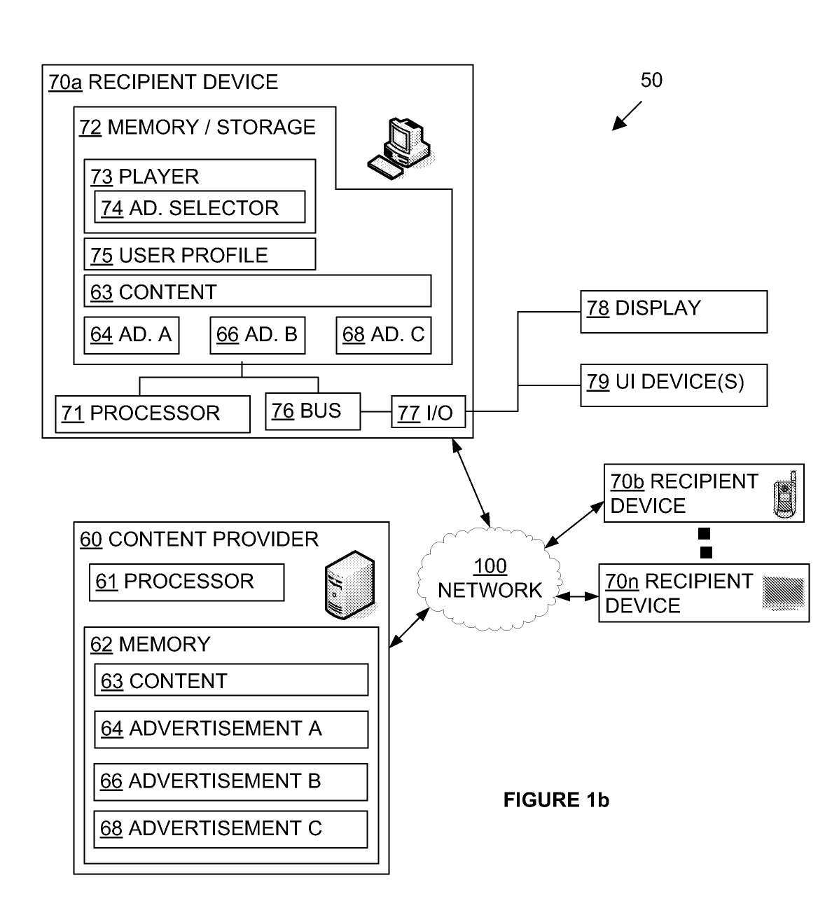

FIG. 2 is a flow chart illustrating an exemplary method 200 of maintaining a local user profile according to certain embodiments. The method 200 of FIG. 2 involves sending a request for content, as shown in block 210. Such a request may be initiated, for example, by a user using his or her computing device to access remote (or possibly locally-stored) content. As a specific example, a user could use recipient device 20a to request content (such as a football video) from a remote content provider 10 to be played on the recipient device's player 23. As another example, a user may request content by selecting a broadcast channel to receive particular content on a cable television, Internet television, or other channel-based electronic device or application.

The exemplary method 200 of FIG. 2 further involves identifying or receiving the requested content, as shown in block 220. Identifying or receiving the requested content can involve receiving none, some, or all of a piece of content. For example, to play a video, a content player may receive an identifier such as a URL from which the content can be progressively retrieved. The content player can progressively retrieve and play the content or parts of it from that location. As examples, progressive download and streaming are two prototypes widely used in video distribution on the web for this purpose. Content providers may use content delivery networks (CDNs) to cache their content geographically closer to users. Some or all of the content can be downloaded/streamed from a CDN server.

The exemplary method 200 of FIG. 2 further involves identifying or receiving information about the requested content, as shown in block 230. Such information can be identified in a variety of ways. For example, the content may include information such as metadata that can be identified. As a specific example, a car racing video may identify keywords identifying aspects of the video's subject matter, such as, for example, “car,” “Ford,” etc. Alternatively, information, such as keywords can be identified by retrieving them from a separate location. For example, a content player could receive a video to play and request information about that video from a separate remote location than the one that provided the video. As another alternative, information may derived from a piece of content through content recognition techniques, e.g., face recognition, voice recognition, scene recognition, etc.

In addition to content-specific information, other types of contextual data can be identified. For example, information can be identified that reflects or suggests the user's viewing habits. Specific examples include the time that the content is viewed, where the user is geographically located, how long the user watched or listened to the content (e.g., 3 minutes of a 10 minute program), and/or whether closed prior to conclusion or not, etc. For example, a content player can determine whether a user is in the United States or in Europe or even a particular region using, as an example, Internet Protocol (IP) address information or other information available to the user's computing device.

The method 200 shown in FIG. 2 further comprises updating a user profile using the information about the requested content, as shown in block 240. This could involve simply adding keywords to a user profile, such as, “car,” “Ford,” etc., that were identified as keywords associated with the viewed content. In addition or as an alternative, various algorithms can be used to build and maintain a user profile. One example involves maintaining a histogram of keywords indicating how many times a given keyword has been associated with the various pieces of content consumed by a user. Keywords can also be added for location, time, and other viewing conditions. Certain exemplary algorithms can be used to estimate user interest in a given piece of content, for example, by identifying content that is viewed multiple times, content that is terminated prior to conclusion, content that is downloaded for off-line use, etc. A user profile can change over time to reflect the most up to date interests of the viewer. For example, in certain embodiments, a user profile can identify user interests using keywords that “decay” over time, e.g., a number value associated with each keyword may be reduced over time and used to weight the relevance of the keyword with respect to other keywords.

In certain embodiments, information about a user is tracked according to the techniques of U.S. patent application Ser. No. 12/127,981, entitled “Systems and Methods for Monitoring Content Consumption,” incorporated herein in its entirety by this reference. Information about a user profile can be also retrieved from external sources, for example, by referencing a database, e.g., the Internet Movie Database (IMDb) or other website to identify information about content that is consumed.

### Exemplary Methods of Selecting Advertisements Using a Local User Profile

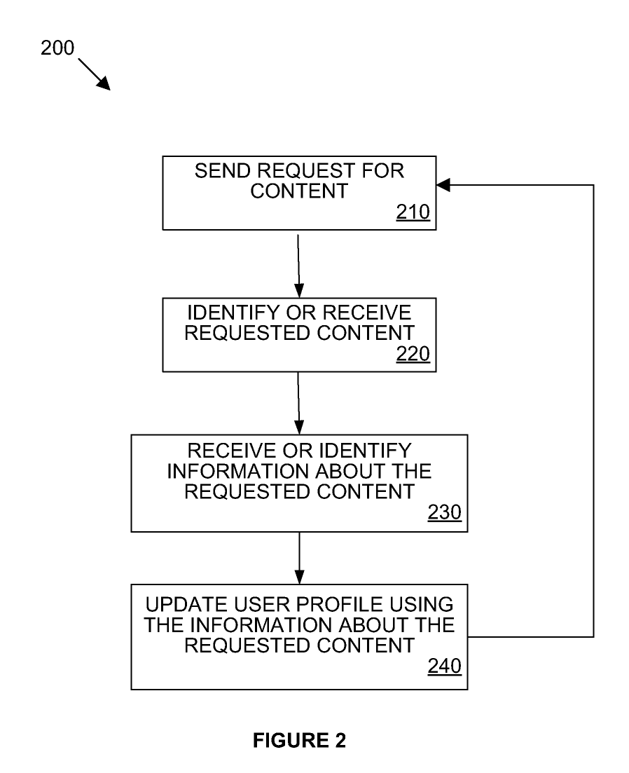

FIG. 3 is a flow chart illustrating an exemplary method 300 of selecting advertisements using a local user profile, according to certain embodiments. Such a method may be performed on a variety of different content viewing playing electronic devices. Generally, any device that uses, retrieves, or plays content can perform some or all of these exemplary steps to achieve various advantages and functions. The method 300 of FIG. 3 involves sending a request for content, as shown in block 310. Such a request may be initiated, for example, by a user using his or her computing device to access remote (or possibly locally-stored) content. As a specific example, a user could use recipient device 20a to request content (such as a football video) from a remote content provider 10 to be played on the recipient device's player 23.

This exemplary method 300 further comprises receiving or identifying the requested content and information about possible advertisements, as shown in block 320. Receiving or identifying the content, for example, can involve receiving none, some, or all of a piece of content. For example, to play a video, a content player may receive an identifier such as a URL from which the video content can be progressively retrieved or streamed.

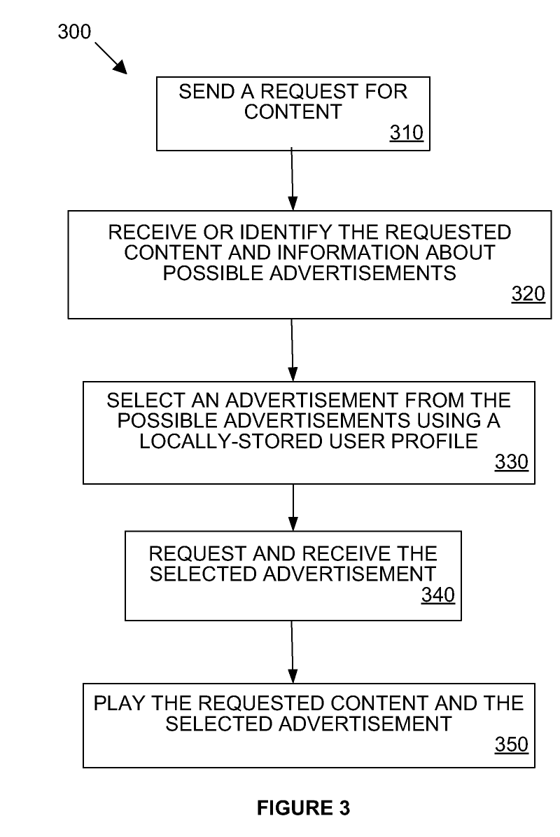

FIG. 4 illustrates an exemplary method 400 of providing content with information about possible advertisements to facilitate selection of an advertisement on a user's device. In one exemplary embodiment, the method 400 of FIG. 4 is performed by a remote content server providing content and/or advertisement information to a client device performing the advertisement selection method 300 of FIG. 3. In FIG. 4, the exemplary method 400 of providing content with information about possible advertisements involves receiving a request for content, as shown in block 410. Such a request may be received through a network or other interface.

The exemplary method 400 of providing content with information about possible advertisements further comprises identifying possible advertisements for playing with the requested content, as shown in block 420. The possible advertisements can be selected using the requested content. For example, if a video is requested, keywords associated with the video, as metadata or otherwise, may be used to select possible advertisements. In other embodiments, possible advertisements are selected without reference to the requested content itself. Possible advertisements can be selected randomly, sequentially, based on an algorithm, or otherwise.

The exemplary method 400 of providing content with information about possible advertisements further comprises providing the requested content and information about the possible advertisements, as shown in block 430. In one exemplary embodiment, a server sends a list of possible advertisements that match the content along with meta information for each advertisement. Such a server may do so in a case where it has identified that a component of the video is an advertisement spot that needs to be filled by an advertisement. For example, the server may identify three possible advertisements for an identified advertisement spot. Each possible advertisement may have some keywords that can be provided to facilitate matching (on the recipient user device) of an appropriate advertisement based on the user profile.

Returning to FIG. 3, after sending the request for content, the exemplary method 300 of selecting advertisements using a local user profile involves receiving the requested content and information about possible advertisements, as shown in block 320. This information can, as an example, be received by a content player application or module on a user's computing device. For example, a player on the user's local device can receive a video and information about the three advertisements, one of which should be played with the video.

The exemplary method 300 of selecting advertisements using a local user profile further involves selecting an advertisement from the possible advertisements using a locally-stored user profile, as shown in block 330. For example, an advertisement can be selected by matching keywords provided in the information about a possible advertisement and keywords associated with the user profile. The matching process may alternatively or in addition also take into account other information, such as the user's current time, location, etc.

In certain embodiments, the user's device takes into account which particular user is logged into the device. This may help address a circumstance where, for example, a computing device that is used by different members of a family may have users with very, different interests. In other embodiments, a user may be identified in other ways. For example, a specific user may be identified prompting the user for a name or by inferring a particular user identity based on user action. In certain embodiments, a computing device will have a single user profile that is generally associated with the device. In other embodiments, a computing device may have more than one user profile associated with the various specific users that use the device.

In certain embodiments, information, including keywords, metadata, and other information, about content and/or advertisements is found according to the techniques of U.S. patent application Ser. No. 12/101,621, entitled “Systems and Methods for Associating Metadata With Media,” incorporated herein in its entirety by this reference.

Once an advertisement is selected from the possible advertisements, the exemplary method 300 of selecting advertisements using a local user profile further involves requesting and receiving that selected advertisement, as shown in block 340, and playing the requested content and the selected advertisement, as shown in block 350. For example, a client device (e.g., a content player on a client device) may send a request to a remote device, such as a remote content or advertisement server to retrieve the advertisement that was selected. The information about the possible advertisement may include information about where each advertisement can be requested from.

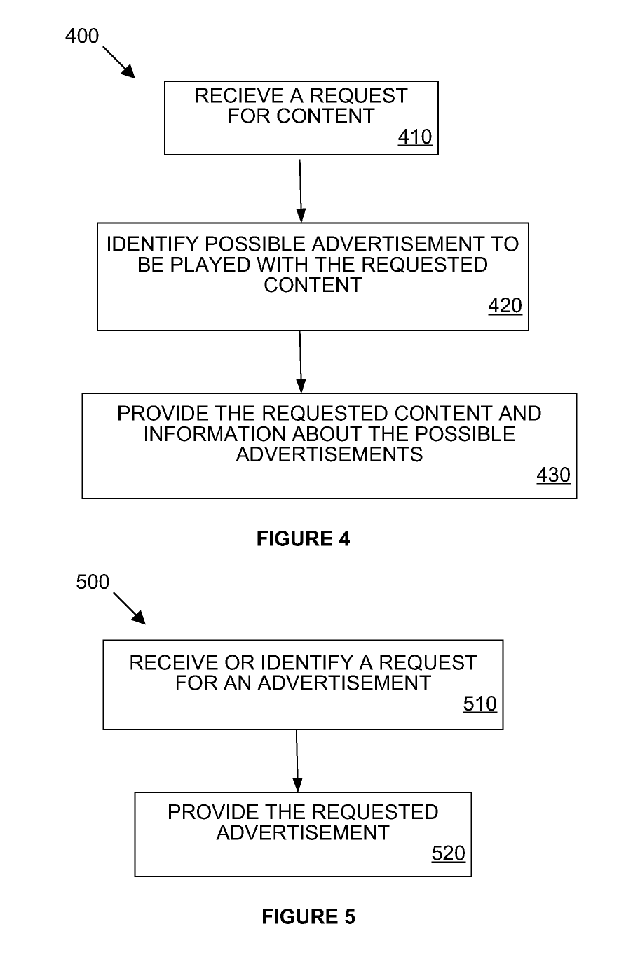

FIG. 5 illustrates an exemplary response to such a request performed by a remote content or advertisement provider, according to certain embodiments. As shown in blocks 510 and 520, this exemplary method 500 involves receiving or identifying the request for a specific advertisement and providing the requested advertisement to the requesting device. In some embodiments, the request provides an indication that the advertisement is needed quickly for use with content that is playing or about to be played. In such cases, the content or advertisement provider may prioritize the request above other requests for content or advertisement.

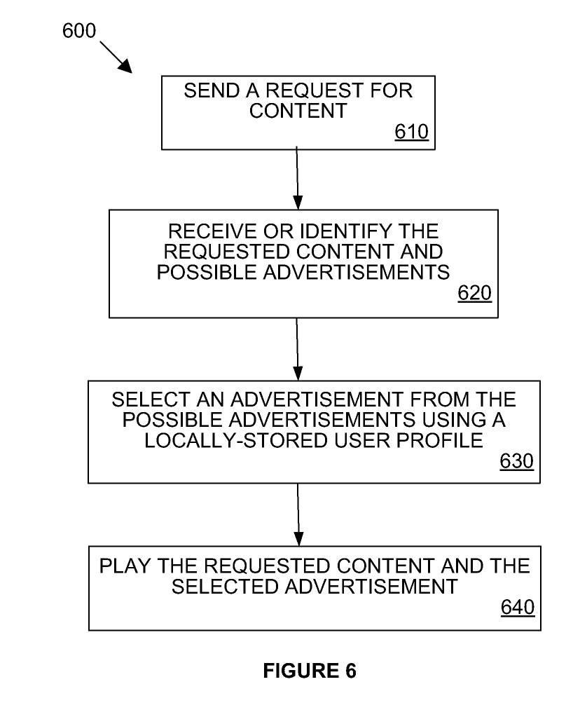

FIG. 6 is a flow chart illustrating another exemplary method 600 of selecting advertisements using a local user profile, according to certain embodiments. Such a method 600 may be performed on a variety of different content viewing playing electronic devices. The method 600 of FIG. 6 involves sending a request for content, as shown in block 610. Such a request may be initiated, for example, by a user using his or her computing device to access content. As a specific example, a user could use recipient device 20a to request content from a remote content provider 10 to be played on the recipient device's player 23.

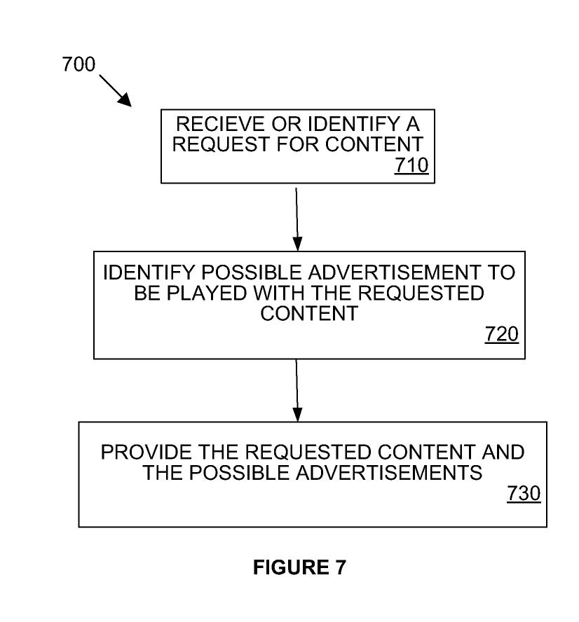

This exemplary method 600 further comprises receiving or identifying the requested content and possible advertisements, as shown in block 620. FIG. 7 illustrates an exemplary method 700 of providing content and possible advertisements to facilitate selection of an advertisement on a user's device. In one exemplary embodiment, the method 700 of FIG. 7 is performed by a remote server providing content and advertisements to a client device performing the advertisement selection method 600 of FIG. 6. In FIG. 7, the exemplary method 700 of providing content with information about possible advertisements involves receiving or identifying a request for content, as shown in block 710. Such a request may be received through a network or other interface.

The exemplary method 700 of providing content with possible advertisements further comprises identifying possible advertisements for playing with the requested content, as shown in block 720. The possible advertisements can be selected using the requested content. For example, if a video is requested, keywords associated with the video, as metadata or otherwise, may be used to select possible advertisements. In other embodiments, possible advertisements are selected without reference to the requested content itself. Possible advertisements can be selected randomly, sequentially, based on an algorithm, using a combination of these techniques, or otherwise.

The exemplary method 700 of providing content with possible advertisements further comprises providing the requested content and possible advertisements, as shown in block 730. In one exemplary embodiment, a server sends possible advertisements that match the content along with the content. Such a server may do so, for example, in a case where it has identified that a component of an audio file is an advertisement spot that needs to be filled by an advertisement. For example, the server may identify one hundred possible advertisements for the identified advertisement spot.

Returning to FIG. 6, after sending the request for content, the exemplary method 600 of selecting advertisements using a local user profile involves receiving the requested content and the possible advertisements, as shown in block 620. The possible advertisements can be provided comprising information or along with information about those possible advertisements. Information about the possible advertisements may also be derived from the possible advertisements themselves.

The exemplary method 600 of selecting advertisements using a local user profile further involves selecting an advertisement from the possible advertisements using a locally-stored user profile, as shown in block 630. For example, an advertisement can be selected by matching keywords provided in the information about a possible advertisement and keywords associated with the user profile.

Once an advertisement is selected from the possible advertisements, the exemplary method 600 of selecting advertisements using a local user profile further involves playing the requested content and the selected advertisement, as shown in block 640. The advertisement and content may be played consecutively, with the advertisement occupying a commercial break in the middle of the content, and/or simultaneously. In some cases, an advertisement and content will be played simultaneously on different portions of an electronic display display.

In these exemplary embodiments, content is provided with information about possible advertisements or with the possible advertisements themselves. Each of these techniques can provide certain advantages and disadvantages with respect to, for example, network traffic and user privacy. For example, receiving the advertisements themselves prior to making a selection, may make it unnecessary to separately request a selected advertisement, avoiding any potential inference that might be made by a server receiving such a request. However, receiving multiple advertisements that will not all be played may create unnecessary or unwanted network traffic. Moreover, it may hinder an advertisement provider's ability to confirm that provided advertisements are actually played. Although this can be addressed, in an alternative embodiment, by providing an anonymous way of measuring the advertising effectiveness by, for example, sending out anonymized advertisement view information to a collection server. In certain embodiments, user preferences, e.g., with respect to privacy, are used to determine whether to provide content (a) with information about possible advertisements or (b) with the possible advertisements themselves.

In addition to providing content with information about possible advertisements or with the possible advertisements themselves, other embodiments provide additional techniques. For example, content may be provided with an identifier that allows information about some or all of the possible advertisements to be separately retrieved. A player selects and displays the ad that best matches the local user profile. In certain embodiments, information, including keywords, metadata, and other information, about content and/or advertisements is found according to the techniques of U.S. patent application Ser. No. 12/101,621, entitled “Systems and Methods for Associating Metadata With Media,” incorporated herein in its entirety by this reference.

### Exemplary Use of Play List and Application Content

Electronic content can be organized as a play list or application to facilitate the user-side addition of one or more advertisements. A piece of content, for example, may comprise logic that essentially allows the content to itself act as a video or other content player. Such a video player can include or use a play list or other logic specifying the insertion of an advertisement at a particular point in time, e.g., play Video A for 5 minutes and then play an advertisement, and then continue playing Video A. A piece of content may include information or instructions that facilitate the playing of an advertisement by a user's content player application. A piece of content may comprise a group of computer files packaged together as a single logical unit. One component of such a group of files may provide a playlist, another component may comprise the actual substance of the requested content, and yet other components may provide information and/or instructions about specifying how the content is played. Generally, however, content can take many forms both simple and complex. For example, for computer content, there are many file formats including, but not limited to, graphics files, sound files, video files, playlist files, and application files, among many others. Content can also have non-file formats as well.

### General

Numerous specific details are set forth herein to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing platform, such as one or more computers or a similar electronic computing device or devices, that manipulate or transform data represented as physical electronic or magnetic quantities within memories, registers, or other information storage devices, transmission devices, or display devices of the computing platform.

The disclosed embodiments are merely illustrative. In short, the techniques and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

That which is claimed:

1. A computer-implemented method comprising:
sending a request for content to play on a computer apparatus, the computer apparatus comprising a content player providing instructions embodied in a computer-readable medium which configure the computer apparatus to play electronic content;
receiving the requested content and information about a plurality of advertisements;
selecting an advertisement from the plurality of advertisements using a user profile that is maintained on the computer apparatus;
requesting and receiving the selected advertisement from a remote source; and
playing the requested content and the selected advertisement on the content player of the computer apparatus.

2. The method of claim 1, wherein the content player of the computer apparatus:
maintains the user profile based at least in part on information about content that was previously requested for playing on the computer apparatus; and
performs the selecting of the advertisement.

3. The method of claim 1, wherein the information about the plurality of advertisements comprises advertisement keywords, and wherein selecting an advertisement comprises matching one or more of the advertisement keywords with keywords associated with the user profile.

4. The method of claim 1, wherein selecting an advertisement is based at least in part on the current time and location and on which particular user is logged into the device.

5. The method of claim 1, wherein:
the computing apparatus comprises more than one user profile; and
selecting the advertisement from the plurality of advertisements using the user profile comprises identifying that the user profile used in the selecting is associated with a current user of the computer apparatus.

6. The method of claim 1, wherein the computing apparatus has a single user profile.

7. The method of claim 1, wherein the information about plurality of advertisements comprises one or more locations from which one or more of the plurality of advertisements can be requested.

8. A computer-implemented method comprising:
sending a request for content to play on a computer apparatus, the computer apparatus comprising a content player providing instructions embodied in a computer-readable medium which configure the computer apparatus to play electronic content;
receiving the requested content and a plurality of advertisements;
selecting an advertisement from the plurality of advertisements using a locally-stored user profile; and
playing the requested content and the selected advertisement.

9. The method of claim 8, wherein the content player of the computer apparatus maintains the user profile based at least in part on information about content that was previously requested for playing on the computer apparatus.

10. The method of claim 8, wherein selecting an advertisement comprises matching one or more keywords identified from the advertisements with one or more keywords associated with the user profile.

11. The method of claim 8, wherein the content player identifies information about the plurality of advertisements, the information comprising keywords about the advertisements.

12. A computer-implemented method comprising:
receiving a request for content, the request received at a computer apparatus comprising instructions embodied in a computer-readable medium which configure the computer apparatus to select and provide electronic content;
identifying that the requested content requires inclusion of an advertisement;
identifying a plurality of advertisements as alternatives for playing with the requested content as the required advertisement, the plurality of advertisements selected based at least in part on requested content; and
providing the requested content and information about the plurality of advertisements in response to the request for content.

13. The method of claim 12, wherein identifying that the requested content requires inclusion of an advertisement comprises identifying that an advertisement spot in a playlist associated with the content needs to be filled by one of the plurality of advertisements.

14. The method of claim 12, wherein identifying the plurality of advertisements comprises matching keywords associated with the requested content to keywords associated with one or more of the plurality of advertisements.

15. The method of claim 12, wherein identifying the plurality of advertisements comprises identifying the plurality of advertisements without determining whether the plurality of advertisements relate to the requested content.

16. The method of claim 12, wherein identifying the plurality of advertisements comprises randomly identifying advertisements from a larger pool of advertisements.

17. A computer-implemented method comprising:
sending a request for content to play on a computer apparatus, the computer apparatus comprising a content player providing instructions embodied in a computer-readable medium which configure the computer apparatus to play electronic content;
receiving the requested content;
identifying information about the requested content; and
updating a user profile using the information about the requested content, wherein the user profile is maintained locally on the computer apparatus and not provided to remote computer devices.

18. The method of claim 17, wherein identifying information about the requested content comprises identifying information about a viewing habit including one or more of:
a time of day that the requested content is played;
a geographic location of the computer apparatus while the requested content is played;
the length of time the requested content was played;
whether the content was played to conclusion without early termination; and
content that is provided with or on a same webpage as the requested content.

19. The method of claim 17, wherein identifying information about the requested content comprises identifying embedded metadata of the requested content.

20. The method of claim 17, wherein identifying information about the requested content comprises requesting the information from a remote location based on the identity of the requested content, wherein the identity of the requested content is determined by retrieving an identifier from the requested content.

21. The method of claim 17, wherein updating the user profile comprises adding keywords to the user profile that were identified as keywords associated with the requested content.

22. The method of claim 17, wherein updating the user profile comprises updating a histogram of keywords indicating how many times a given keyword has been associated with the various pieces of content played by the computer apparatus.

23. A computer apparatus comprising:
a content player that sends requests for content to play on a computer apparatus, the content player providing instructions embodied in a computer-readable medium which configure the computer apparatus to receive and play electronic content; and
an advertisement selector for selecting an advertisement from various possible advertisements using a user profile that is maintained locally on the computer apparatus and not provided to remote computer devices;
wherein the content player plays received content with advertisements selected by the advertisement selector.

24. A computer-readable medium on which is encoded program code, the program code comprising:
program code for sending a request for content to play on a computer apparatus, the computer apparatus comprising a content player providing instructions embodied in a computer-readable medium which configure the computer apparatus to play electronic content;
program code for receiving the requested content and information about possible advertisements;
program code for selecting an advertisement from the possible advertisements using a user profile that is maintained locally on the computer apparatus and not provided to remote computer devices;
program code for requesting and receiving the selected advertisement from a remote source; and
program code for playing the requested content and the selected advertisement on the content player of the computer apparatus.
